(19) United States
(12) Patent Application Publication
(10) Pub. No.: US 2024/0365175 A1
(43) Pub. Date: Oct. 31, 2024

(54) METAVERSE SERVICES WITH NETWORK SLICING

(71) Applicant: Samsung Electronics Co., Ltd., Suwon-si (KR)

(72) Inventor: Prakash Reddy Kolan, Plano, TX (US)

(21) Appl. No.: 18/632,162

(22) Filed: Apr. 10, 2024

Related U.S. Application Data
(60) Provisional application No. 63/462,107, filed on Apr. 26, 2023.
(60) Provisional application No. 63/468,691, filed on May 24, 2023.

(51) Int. Cl. H04W 28/24; H04W 4/50; H04W 28/26

(52) U.S. Cl. CPC H04W 28/24; H04W 4/50; H04W 28/26

(57) ABSTRACT

A method includes receiving a request for a Metaverse service. The method also includes identifying one or more service anchors associated with (i) a field of view of a user and (ii) preferences of the user. The method further includes selecting a service anchor from the one or more service anchors based on a condition. In addition, the method includes determining one or more edge networks and one or more network slices based on (i) the request and (ii) the service anchor. The method also includes provisioning the Metaverse service using the one or more network slices and the one or more edge networks.

### CROSS-REFERENCE TO RELATED APPLICATION AND PRIORITY CLAIM

This application claims priority under 35 U.S.C. § 119 (e) to U.S. Provisional Patent Application No. 63/462,107 filed on Apr. 26, 2023, and U.S. Provisional Patent Application No. 63/468,691 filed on May 24, 2023, which are hereby incorporated by reference in its entirety.

### TECHNICAL FIELD

This disclosure relates generally to multimedia devices and processes. More specifically, this disclosure relates to Metaverse services with network slicing.

### BACKGROUND

The Metaverse is the next generation technology where managed virtual worlds provide immersive experiences to end users. Because of the Metaverse, the boundary between physical and virtual world is being erased facilitating interactions between virtual and physical objects, including humans, resulting in enhanced immersive experiences for the participating users. The fundamental technologies behind the Metaverse are augmented reality (AR), virtual reality (VR), and mixed reality (MR). Users may look for differentiated experiences, which a mobile network operator (MNO) and service provider try to take of advantage of.

### SUMMARY

This disclosure provides Metaverse services with network slicing and edge computing.

In a first embodiment, a method includes receiving a request for a Metaverse service. The method also includes identifying one or more service anchors associated with (i) a field of view of a user and (ii) preferences of the user. The method further includes selecting a service anchor from the one or more service anchors based on a condition. In addition, the method includes determining one or more edge networks and one or more network slices based on (i) the request and (ii) the service anchor. The method also includes providing the Metaverse service using the one or more network slices and the one or more edge networks.

In a second embodiment, an application function includes a transceiver and a processor. The processor is configured to receive, via the transceiver, a request for a Metaverse service. The processor is also configured to identify one or more service anchors associated with (i) a field of view of a user and (ii) preferences of the user. The processor is further configured to select a service anchor from the one or more service anchors based on a condition. In addition, the processor is further configured to determine one or more edge networks and one or more network slices based on (i) the request and (ii) the service anchor. The processor is also configured to provide the Metaverse service using the one or more network slices and the one or more edge networks.

In a third embodiment, a non-transitory computer readable medium containing instructions that when executed cause a processor to receive a request for a Metaverse service. The instructions that when executed also cause the processor to identify one or more service anchors associated with (i) a field of view of a user and (ii) preferences of the user. The instructions that when executed further cause the processor to select a service anchor from the one or more service anchors based on a condition. In addition, the instructions that when executed cause the processor to determine one or more edge networks and one or more network slices based on (i) the request and (ii) the service anchor. The instructions that when executed also cause the processor to provide the Metaverse service using the one or more network slices and the one or more edge networks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIGS. 2 and 3 illustrate example electronic devices in accordance with an embodiment of this disclosure;

FIG. 4 illustrates an example localized mobile Metaverse service use case in accordance with an embodiment of this disclosure;

FIG. 5 illustrate example network slicing options with Metaverse services in accordance with an embodiment of this disclosure;

FIG. 6 illustrates an example SLA management for Metaverse services in accordance with an embodiment of this disclosure;

FIG. 7 illustrates an example premium service anchors with network slicing in accordance with an embodiment of this disclosure;

FIG. 8 illustrates example edge deployments of different localized Metaverse services in accordance with an embodiment of this disclosure;

FIG. 9 illustrates an example application service provider configuration of different localized Metaverse services in different edge data networks in accordance with an embodiment of this disclosure;

FIG. 10 illustrates an example edge network host or edge network replacement for localized Metaverse services in accordance with an embodiment of this disclosure;

FIG. 11 illustrates an example Metaverse service with users from different Metaverse worlds in accordance with an embodiment of this disclosure;

FIG. 12 illustrates an example connected edge for peer Metaverse world edge orchestration provisioning in accordance with an embodiment of this disclosure; and

FIG. 13 illustrates an example method for Metaverse services with network slicing according to this disclosure.

### DETAILED DESCRIPTION

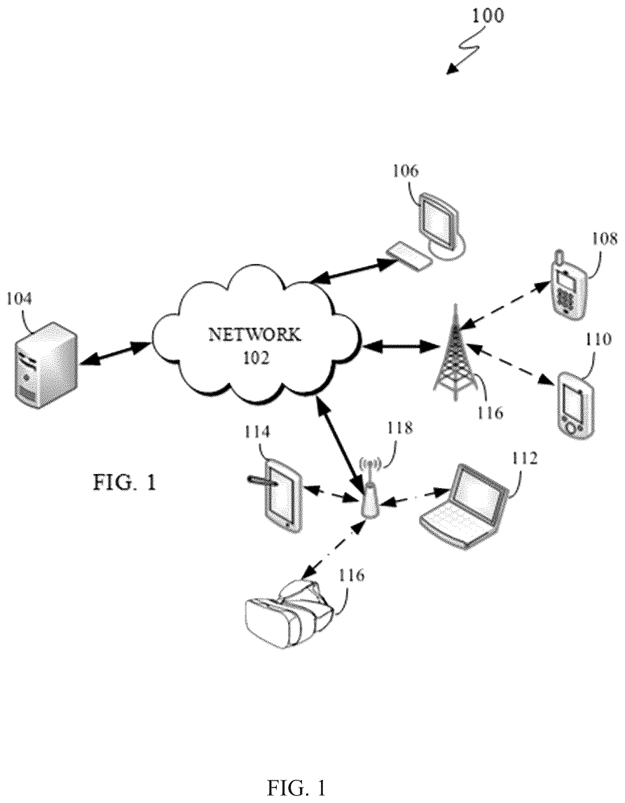

FIGS. 1 through 13, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

Metaverse is assumed to be one of the killer apps for 5G, B5G, and 6G deployments. Metaverse technology is at very early stage of development. Many issues related to quality of service (QOS), security, identity verification, transport mechanisms etc. are still being developed. Without addressing these problems, Metaverse services may not become mainstream in next generation networks.

Requirements and potential use-cases for Metaverse Services are being currently studied in different standards groups and external organizations. End user's presence and current context (e.g., physical location, temporal etc.) are one of the important considerations for identifying and accessing Metaverse Services. Localized Metaverse Services are being researched and gaps being identified. This disclosure describes methods and procedures for service optimization for delivering Localized Metaverse Services to end users. Further, the disclosure describes a method for differentiated offerings for Localized Metaverse Services using Network Slicing. With this, MNOs and service providers can provide differentiated Metaverse Services for users with different level of subscription, interest, etc.

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included a given device is increasing. Even with the increase of processing power portable electronic devices often struggle to provide the processing capabilities to handle new services and applications, as newer services and applications often require more resources that is included in a portable electronic device. Improved methods and apparatus for configuring and deploying media processing in the network is required.

Cloud media processing is gaining traction where media processing workloads are setup in the network (e.g., cloud) to take advantage of advantages of the benefits offered by the cloud such as (theoretically) infinite compute capacity, auto-scaling based on need, and on-demand processing. An end user client can request a network media processing provider for provisioning and configuration of media processing functions as required.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. One or more of the client devices 106-116 include circuitry, programming, or a combination thereof, for utilizing Metaverse services with network slicing in a communication system. The server 104 can represent one or more servers, for example, an application function. Each server 104 includes any suitable computing or processing device that can provide computing services for one or more client devices, such as the client devices 106-116. Server 104 includes circuitry, programming, or a combination thereof, for providing Metaverse service with network slicing in a communication system Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

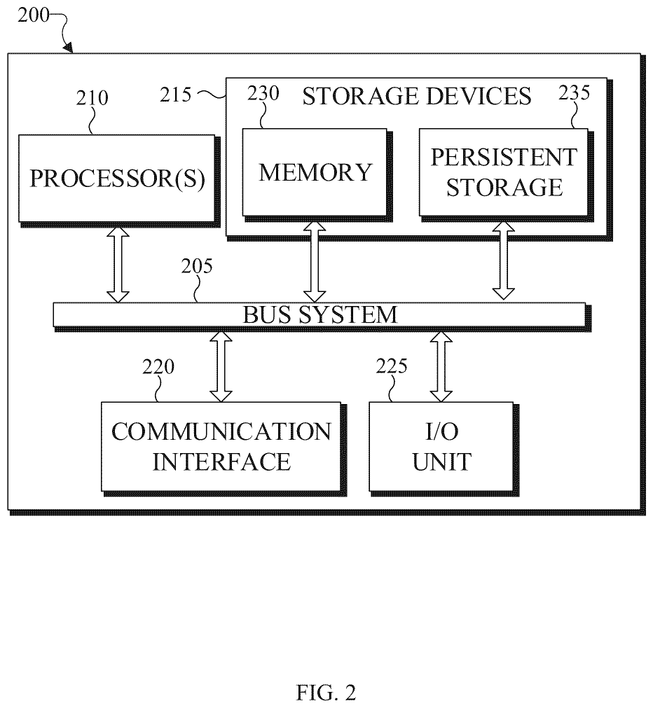

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 is capable of executing programs and other processes resident in the memory 230, such as processes for providing Metaverse services with network slicing in a communication system. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as processes for utilizing Metaverse services with network slicing in a communication system. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

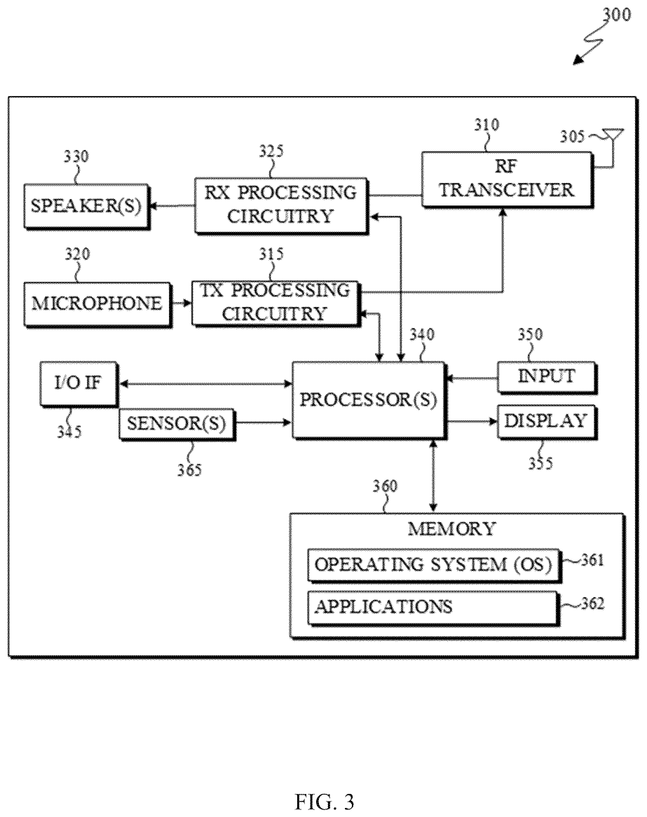

FIG. 4 illustrates an example localized mobile Metaverse service use case 400 in accordance with an embodiment of this disclosure. The embodiment of the localized mobile Metaverse service use case 400 illustrated in FIG. 4 is for illustration only. FIG. 4 does not limit the scope of this disclosure to any particular implementation of an electronic device.

As shown in FIG. 4, the AR annotation provides much more than an augmented map. For example, the user is going to catch a train. A first AR annotation 402 for a path to the platform is shown without obstructing the user's perception of their proximity, where the contrast is good, and no distractions appear. A second AR annotation 404 is used for the store on the right that may be relevant to the potential shopper. The second AR annotation 404 can provide content such as the store's opening hours. Further along, a third AR annotation 406 indicates a restaurant. The third AR annotation 406 can provide a personalized message, reminding the user that they ate there in the past and ordered soup. These services are linked to the space that the user is in.

The displayed three AR annotations 402-406 are the result of different sources of information. The AR annotations 402 related to the path can be presented anywhere that the information fits into the scene, where the AR annotations 404 and 406 for the store and the restaurant are anchored in space.

Depending on user's location, services are anchored in space and the user is provided with the service enabler option so the user can activate the service that is anchored at a specific point the user's space. For example, a service anchor can exist where a product (“Blue Lotion”) in a specific store is being offered at certain price. Such an offering is based on analysis of a user's past history, which shows that the user was interested in either buying that specific product or was interested in buying something similar. When the UE, with the user's past history information, senses that being in close proximity of a store with such a product and since the store is providing a Metaverse service for product offerings in the same MNO that the UE is currently connected with, the UE application pops up the service anchor and provides the user the ability to invoke the checkout service for that specific product.

Instead of a checkout service anchor, different types of service anchors could be possible with different types of media e.g., audio, video, tactile, etc. For example, when the UE is in close proximity of a service delivery point, a service anchor can be provided to the user that allows the user to watch a high throughput video, or his backpack, a tactile client, starts vibrating to signal an important notification to the user.

When there are multiple service anchors, i.e., a number of localized Metaverse services are available for the user at any point in time, the service experience of users can be enhanced by enhancing the service access information of each of the services at different service anchor points.

When there are two or more localized Metaverse services available to the UE at a given location, each service can be specified with a point-of-time service priority. This service priority for the localized Metaverse service can be changing depending on a number of factors such as the shown in TABLE 1.

TABLE 1

| Reason for change | Description |
|---|---|
| Current | Depending on current location, the |
| location | service priority of a localized Metaverse |
| | service could be different. If service |
| | anchors for two or more Metaverse services |
| | are in the vicinity of end user, then the |
| | service with a service anchor that is closest |
| | to the end user can have the highest service |
| | priority comparted to a service whose service |
| | anchor is relatively far. Thus, as the user's |
| | location changes, the service priority changes. |
| User | Depending on user's preferences, the service |
| preferences | priority could be different. For example, |
| | if the user is on the way to an interview, |
| | then a service that can aid in user's interview |
| | (e.g., a bookstore service anchor) can |
| | receive the higher priority compared to other |
| | services (e.g., of a food store). The service |
| | provider can provide for the ability for the |
| | user to define his/her own user preferences |
| Current | Time of day could determine the service |
| time | priority. For example, when a user is going |
| | home in the evening, then a service that provides |
| | an enhanced meal experience might receive higher |
| | priority than another service such as a library |
| | localized service |

Although FIG. 4 illustrates an example localized mobile Metaverse service use case, various changes may be made to FIG. 4. For example, the number and placement of various components of the localized mobile Metaverse service use case 400 can vary as needed or desired. In addition, the localized mobile Metaverse service use case 400 may be used in any other suitable process and is not limited to the specific processes described above.

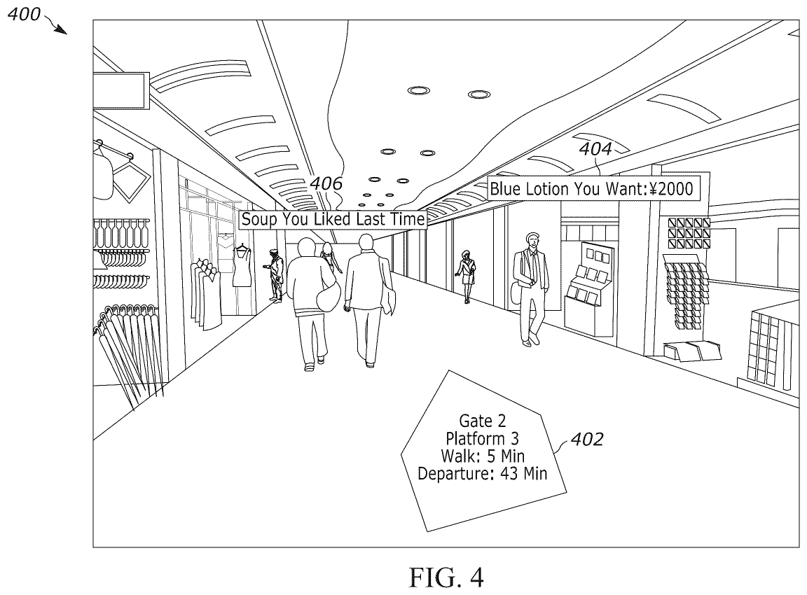

FIG. 5 illustrate example network slicing options 500 with Metaverse services in accordance with an embodiment of this disclosure. The embodiment of the network slicing options 500 illustrated in FIG. 5 is for illustration only. FIG. 5 does not limit the scope of this disclosure to any particular implementation of an electronic device.

As shown in FIG. 5, different service anchors 502 provide access to a different service. The type of service available at a service anchor 502 can be specified by service access information. When such service access information is retrieved by the end user, the end user's client device, or the application installed in the end device, can access the service access information and invoke the necessary device endpoints (e.g., a media player to play certain video to the end user). To enable differentiated services provided with service anchors 502, the service access information with enhanced with the following information.

Information about network slices 504 to be used to access the media type traffic associated with the service at that service anchor 502. To enable differentiated QoS for media component streams for the service at the service anchor 502, one or more network slice information descriptors can be provided. A network slice information descriptor can be provided for each type of media type of traffic. For example, a service at service anchor 502 can include three component streams and the service access information can specify different network slices, where one network slice can be specified for each type of the component streams. With this option, the service at the service anchor 502 can receive differentiation QoS compared to other localized Metaverse services.

Differentiated QoS information relative to the main service: Instead of specifying separate QoS for each component stream for the service at the service anchor 502, a service level QoS information can be specified. For any media component stream for the service at the service anchor 502, if there is a necessity for differentiated QoS for one or more the streams, then just those component streams can be specified with separate QoS information compared to the service level QoS information.

For each service for a different service anchor 502, one or more network slice identifications can be attributed because of which different services get differentiated QoS and traffic isolation as desired. Such differentiated QoS and traffic isolation is possible due to the provisioning and configuration requested by the localized Metaverse service provider.

In certain embodiments, a single network slice 504 for an entire Metaverse service can be utilized. A slice 504 can be provisioned by the MNO 506 for transferring any component stream 508 associated with the any service anchor 502 within the Metaverse service. This is the lowest granularity of network slicing, i.e., all service anchors 502 within the Metaverse get the same traffic treatment irrespective of service priorities. This case can also be referred to as the “Metaverse as a Slice” service. In 5G world, Metaverse as a slice can be achievable and deployable. 3GPP has standardized different types of network slices 504 so far (eMBB, uRLLC, mIoT, V2X etc.). Realizing this case can require specification of a new slice type e.g., XR in 3GPP.

In certain embodiments, a separate network slice 504 can be utilized per service anchor 502. In this option, a separate network slice 504 can be provisioned by the MNO 506 for each service anchor 502 within the Metaverse service. With this option, different QoS levels and traffic treatments can be provisioned for each of the service at the service anchor 502 within the Metaverse service. Using service priorities enhances the dynamic provisioning and allocation of QoS policies for treating traffic related to a single service anchor 502.

In certain embodiments, a separate network slices 504 can be utilized per traffic type. With this option, a separate network slice 504 is provisioned by the MNO 506 for each type of component stream 508 associated with a service anchor 502. This is the highest level of granularity that an operator can provision for Metaverse services. This option, even though theoretically possible, can be extremely process and cost intensive for the operator to provision. This option seems unlikely, at least in the short term, but with B5G and 6G networks, this can be a real possibility.

In certain embodiments, the MNO operator 506 can provide a separate network slice 504 for each type of traffic for all service anchors 502. For example, if multiple service anchors 502 involve a video stream, the MNO 506 can provision a separate network slice 504 for video traffic type. The same can be done for other traffic types.

Although FIG. 5 illustrate example network slicing options 500 with Metaverse services, various changes may be made to FIG. 5. For example, the number and placement of various components of the network slicing options 500 can vary as needed or desired. In addition, the network slicing options 500 may be used in any other suitable process and is not limited to the specific processes described above.

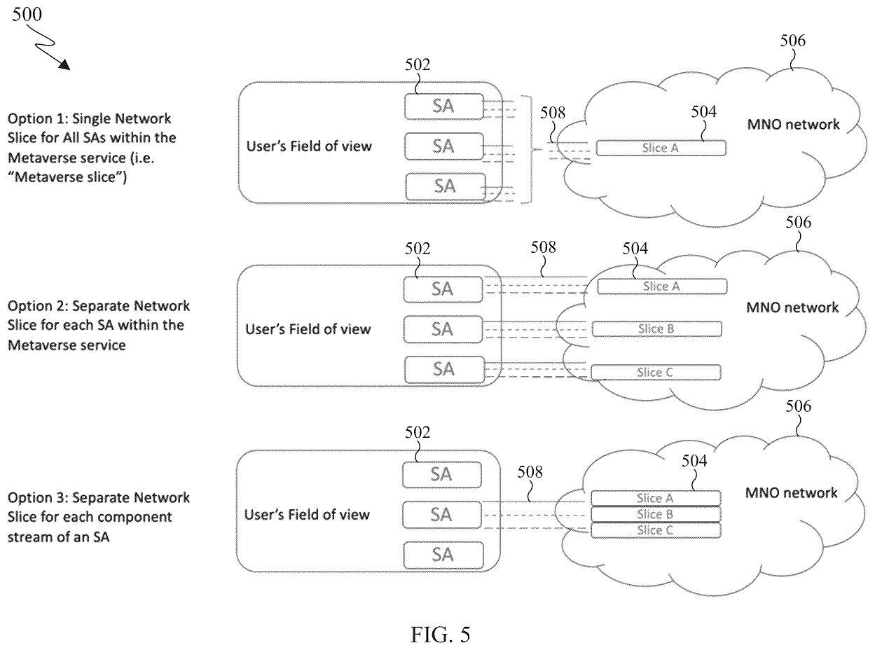

FIG. 6 illustrates an example SLA management 600 for metaverse services in accordance with an embodiment of this disclosure. The embodiment of the SLA management 600 illustrated in FIG. 6 is for illustration only. FIG. 6 does not limit the scope of this disclosure to any particular implementation of an electronic device.

As shown in FIG. 6, dynamic SLA management for Metaverse services 604 can be provided within a single network slice 504. In traditional SLA methods with network slicing, the service provider usually interacts with the MNO network and requests provisioning of a network slice 504 for the service with certain requirements (e.g., using the network embedded system technology (NEST) template defined by Groupe Special Mobile Association (GSMA) organization). The MNO creates and provisions a network slice 504 and informs the service provider so the service provider can activate the service within the network slice 504. With such an activation and provisioning of a network slice 504, certain processing (physical and virtual) and network resources are orchestrated for managing the traffic of the service.

For example, for a Metaverse service 604 that is using a single network slice 504, the SLA requirements requested by the service provider is constructed based on individual SLA requirements for each of the services at different service anchors 502 available to the end user. In the end, the total SLA provisioned for the network slice 504 is an aggregation of individual SLA 602 of each of the services accessed through different service anchors 502 in the user's field of view.

The SLA 602 for service anchor 502 is dependent upon the SLA requirements for each of the service associated with each of the service anchor 502 in the user's field of view. The SLA requirements of the service associated with an service anchor 502 can be any of latency requirements, throughput requirements, bandwidth requirements, any other requirement standardized as part of NEST template by GSMA organization, and any other requirement standardized in 3GPP.

In regard to the SLA 602 of the network slice 504 offered for the Metaverse service 604, optimizations can be defined based on physical proximity and user access. For dynamic update of network slice 504 SLA 602 based on physical proximity of user to the service anchor 502. When the user is closer to a service anchor 502, the SLA decomposition of slice SLA 602 to individual services gives preference to the service whose service anchor 502 is closer to the end user. For example, if the user is able to see two service anchors 502 whose aggregate SLA 602 comprise the overall SLA 602 of the network slice 504. If the initial SLA decomposition resulted in a 50-50 split of slice resources to each of the services, then when the user gets close to one of the service anchor 502, then the amount of slice resources allocated to that service is increased (e.g., 70%) compared to the service at the other service anchor 502. The amount of such increase can be provisioned by the service provider. Similar provisioning can be performed by the service provider if there are multiple service anchors 502 associated with the Metaverse service 604.

Dynamic update of the SLA 602 of a network slice 504 based on user's access to the service anchor 502. With this option, irrespective of what service anchor 502 is closer to the user, the service that is being currently accessed by the user gets the preferential treatment on the slice resources allocated to the service.

For Metaverse service with multiple network slices 504 (e.g., Option 2 or Option 3 in FIG. 5), the following optimizations for SLA management can be defined for slice identification and activation of services and for slice resources. Slice identification and activation for the services that are in the user's field of view can be performed. Slice resources are allocated depending on user's proximity to the localized services within the Metaverse service 604.

Slice resources are “reserved” for services for service anchor 502 that are in user's current viewpoint. When the user gets closer to their corresponding service anchors 502, the slice life cycle is advanced by activating the service anchors 502 from the reserved stage. At this time, the slice resources are also allocated and instantiated to receive potential traffic from the end user.

The above SLA management methods can also be based on current user's access i.e., a network slice 504 can be activated for services that are being currently requested by the end user instead of just looking at the physical proximity to the localized services. Optimization for network slicing operations can be performed for localized services using the options in TABLE 2.

TABLE 2

| Optimization operations | Description |
|---|---|
| Network | Localized Metaverse service with |
| slice | highest service priority can be |
| assignment | assigned for a network slice with |
| | best current performance and availability |
| Network | If a service with highest service |
| slice | priority is running in a network slice |
| replacement | with not-so-optimal performance, then |
| | this service is given preference in |
| | network slice replacement processes |
| | and network slice instance replacement |
| | processes. As part of the network slice |
| | replacement process, constituent component |
| | streams of higher priority service can |
| | be sent through another slice with |
| | better performance |
| Network slice | Localized Metaverse services with |
| splitting or | higher service priority are given |
| steering | preference if constituent traffic |
| | is to be split or steered through |
| | another network slice for optimizing |
| | end-to-end performance. |

Resource optimization can be performed for localized services using the options in TABLE 3.

TABLE 3

| Optimization operations | Description |
|---|---|
| Slice | In a shared slice scenario, the amount |
| resource | of resources allocated to a localized Metaverse |
| allocation | service with higher service priority is more |
| | compared to a service with relatively lower |
| | service priority. Since usually all the |
| | localized Metaverse service are in vicinity |
| | to the end user, it is highly likely that |
| | all the services compete for processing |
| | resources in the same slice. Hence a |
| | resource allocation scheme using service |
| | priority and network slicing can help in |
| | resource allocation decisions. |
| Slice | Scaling of resources (e.g., scale-in/ |
| resource | scale-out/scale-up/scale-down) of slice |
| scaling | resources is based on service priorities. |
| | I.e., services with higher service priority |
| | get preferential treatment during slice |
| | resource scaling processes. |

Although FIG. 6 illustrates an example SLA management for Metaverse services in accordance with an embodiment of this disclosure, various changes may be made to FIG. 6. For example, the number and placement of various components of the SLA management 600 can vary as needed or desired. In addition, the SLA management 600 may be used in any other suitable process and is not limited to the specific processes described above.

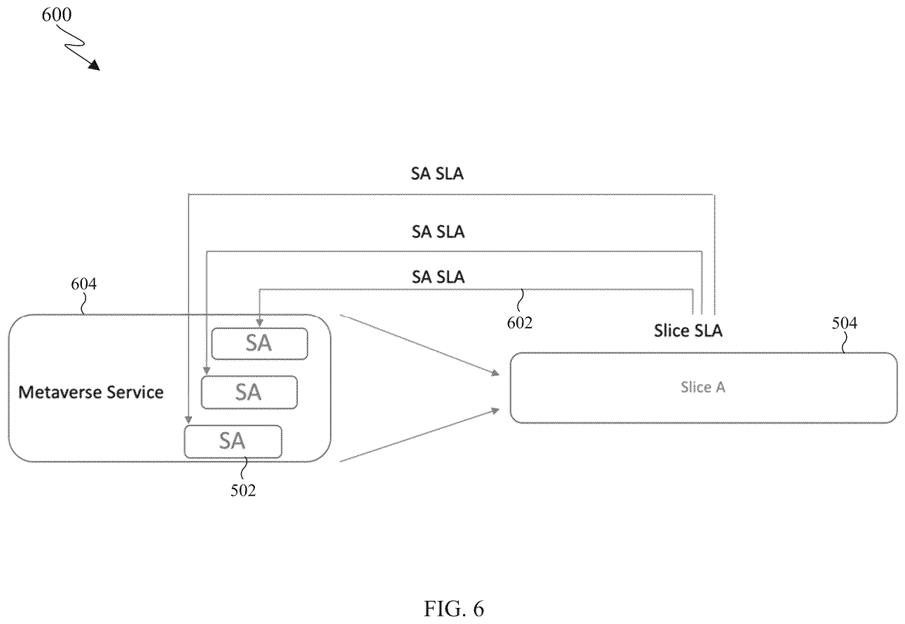

FIG. 7 illustrates an example premium service anchors 700 with network slicing in accordance with an embodiment of this disclosure. The embodiment of the premium service anchors 700 illustrated in FIG. 7 is for illustration only. FIG. 7 does not limit the scope of this disclosure to any particular implementation of an electronic device.

As shown in FIG. 7, premium service anchors 700 can provide premium localized Metaverse services 702. With network slicing, premium service anchors 700 for premium localized Metaverse services 702 can be offered to the end users. As shown in FIG. 7 below, some of the service anchors 502 could be regular services, and some of the service anchors 700 could be of premium services.

A service anchor 700 for a premium service involves delivery of a respective service with an optimized network slice 504, i.e., better suited for that Metaverse service 702 based on the service level agreement (SLA) 602. A Metaverse service 702 can involve service anchors 502 for regular services and service anchors 700 for premium services in the user's environment at the same time. Selection choices may be provided to the end user describing the difference between a regular service and a premium service. Depending on the localized Metaverse service 702, the end user may pick either the regular service or a premium service.

One way to realize premium service is through usage of service priority defined earlier in the disclosure. Network slicing information may be included in the service access information for premium services for using a separate/dedicated network slice 504.

Depending on user's location, subscription (temporary or permanent), delivery of a service could be performed through premium slicing (temporary or permanent). For example, a user physically in the airport, taking part in an online Metaverse gaming service, could temporarily request premium upgrade of his service so the user's content gets processed in a local edge instead of a remote cloud.

Premium services enable differential offering of same service-e.g., diamond level, gold level, etc. One of the well-suited network enablers to offer such a differentiation is network slicing.

In certain embodiments, TR 22.856 specifies a study of localized Metaverse services 702 and includes a number of potential use-cases and requirements for Metaverse services 702. Clause 5.1 of TR 22.856 describes the use case of localized Metaverse service 702 with service anchors 502 placed in user's field of view for the user to choose if the user wants to access that service. The use case describes a scenario where in the user is walking in an airport and is presented with a number of localized Metaverse services that the user can access. These services are provided as service anchors 502 in the user's physical environment. The user may select the service that the user wants to access and invoke the Metaverse service 702.

In certain embodiments, a use case can provide when an end user is driving a car on the way to a repair shop. A Metaverse service scene can be presented to the end user with a multitude of services that the end user can access, e.g., map service, music service, and shopping service. The end user may have his car in auto-driving mode and invokes the service anchor 502 corresponding to the shopping service to buy tires for his car before the user reaches the repair shop. The end user may wish to stream audio/video content related to the products the user is buying. A best effort network might not be serving the end user's needs. The end user activates a premium subscription service to perform his tasks.

Although FIG. 7 illustrates an example premium service anchors with network slicing, various changes may be made to FIG. 7. For example, the number and placement of various components of the premium service anchors 700 can vary as needed or desired. In addition, the premium service anchors 700 may be used in any other suitable process and is not limited to the specific processes described above.

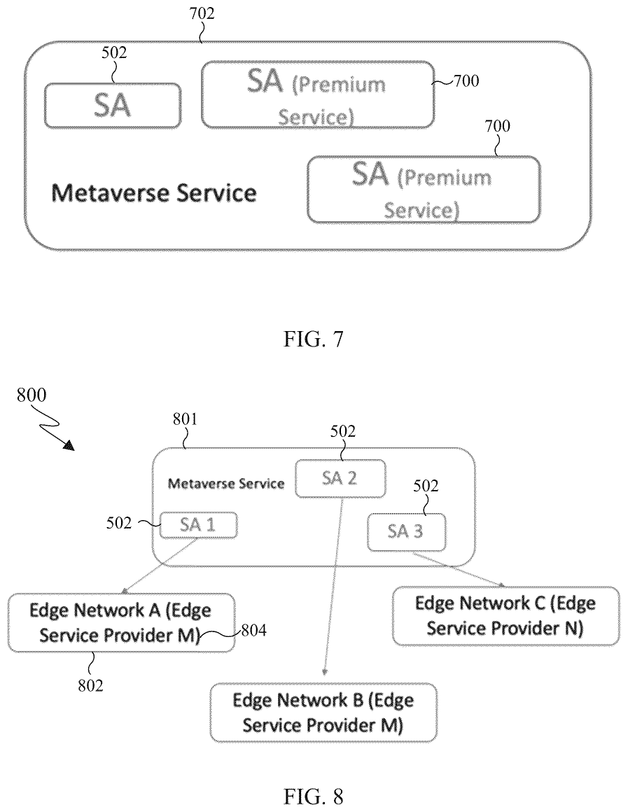

FIG. 8 illustrates example edge deployments 800 of different localized Metaverse services in accordance with an embodiment of this disclosure. The embodiment of the edge deployments 800 illustrated in FIG. 8 is for illustration only. FIG. 8 does not limit the scope of this disclosure to any particular implementation of an electronic device.

As shown in FIG. 8, edge deployments 800 includes providing edge network configuration for service anchors 502. Traditional media services have had edge deployments where in the MNO has agreements with one or more edge service providers for certain orchestration needs, and the MNO facilitates creation of 5G media services could use the edge service provider platform. Typically, a service accessed an edge data network 802 in an edge service provider network 804. MNO could facilitate deployment of multiple edge networks, but a user request could go to an edge network 802 of an edge service provider network 804. Some other times, the edge network 802 could be pointed to a different edge service provider network 804 by the operator.

In certain embodiments, a Metaverse service 801 can have multiple service anchors 502, where each service at a different service anchor 502 could be deployed in a different edge network 802 of different edge service provider networks 804.

Services at service anchors SA1 and SA2 are deployed in two different edge networks 802, but provided by the same edge service provider 804, but a different service at service anchor SA3 runs in a separate edge network 802 of a different service provider network 804.

Where to run each of the services at different service anchors 502 is known to the operator, and the operator performs offline negotiation with an application service provider to exchange information about available edge network deployment options in different edge service provider networks 804.

An application service provider, when setting up Metaverse services 801, can configure the Metaverse service 801 with different service anchors 502 to be deployed at different edge networks 802 of different edge service provider networks 804.

Although FIG. 8 illustrates example edge deployments of different localized Metaverse services, various changes may be made to FIG. 8. For example, the number and placement of various components of the edge deployments 800 can vary as needed or desired. In addition, the edge deployments 800 may be used in any other suitable process and is not limited to the specific processes described above.

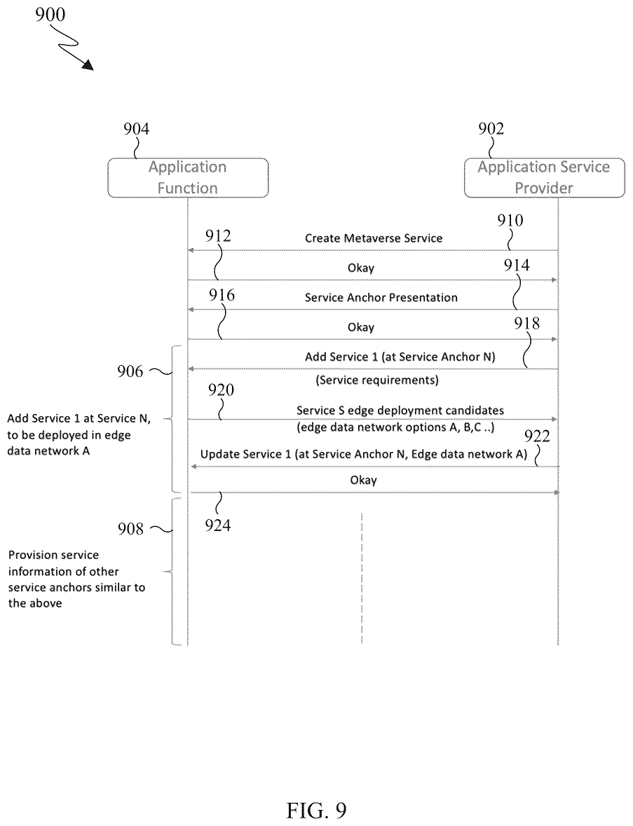

FIG. 9 illustrates an example application service provider configuration 900 of different localized Metaverse services in different edge data networks in accordance with an embodiment of this disclosure. The embodiment of the application service provider configuration 900 illustrated in FIG. 9 is for illustration only. FIG. 9 does not limit the scope of this disclosure to any particular implementation of an electronic device.

As shown in FIG. 9, the application service provider configuration 900 includes the steps below for configuring a Metaverse service with multiple service anchors with different edge data network deployments.

The application service provider (ASP) 902 requests creation of a Metaverse service at the application function (AF) inside the operator network in step 910. The application function could be the 5GMS AF specified in TS 26501 and TS 26512. The AF 904 responds with a positive response in step 912. The ASP 902 sends service anchor presentation information in step 914. This information consists of details of all services, service anchor location information inside the scene to build. The AF 904 responds with a positive response in step 916.

The ASP 902 requests to add a first service 906 at a service anchor created as part of step 918. With this request, the ASP 902 sends the service requirements of the service to run at the service anchor. As part of the request, ASP 902 requests enablement of edge deployment for this service. The AF 904, given the service requirements, provides with a set of edge data network options in step 920.

The ASP 902 picks an edge data network, updates the service configuration at the service anchor with the edge data network to choose for deployment in step 922. Along with the chosen edge network, the ASP 902 can also send service deployment details. The AF 904 responds with a positive response indicating support that the AF 904 can ensure deployment of that service at the requested edge data network in step 924.

Similar to deployment for the first Service 906 above as shown in steps 918-924, remaining services 908 as part of the Metaverse service can be requested for deployment by the ASP 902 in the operator network. When AF 904 gets the service deployment request from the ASP 902, the AF 904 can interface with different edge data networks in different edge service provider networks for deployment of the application servers necessary to provide support to users' request for application processing.

Although FIG. 9 illustrates an example application service provider configuration of different localized Metaverse services in different edge data networks, various changes may be made to FIG. 9. For example, the number and placement of various components of the application service provider configuration 900 can vary as needed or desired. In addition, the application service provider configuration 900 may be used in any other suitable process and is not limited to the specific processes described above.

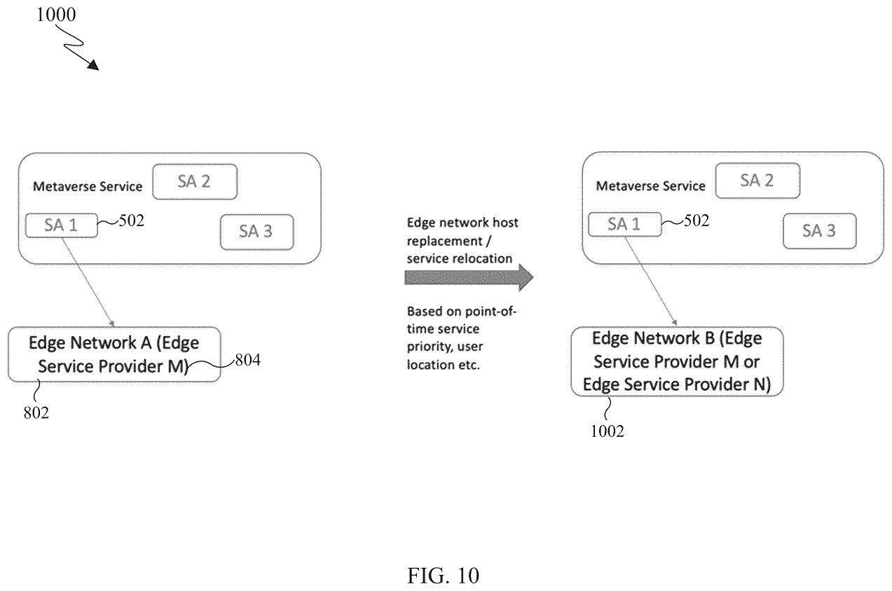

FIG. 10 illustrates an example edge network host or edge network replacement 1000 for localized Metaverse services in accordance with an embodiment of this disclosure. The embodiment of the network replacement 1000 illustrated in FIG. 10 is for illustration only. FIG. 10 does not limit the scope of this disclosure to any particular implementation of an electronic device.

As shown in FIG. 10, network replacement 1000 provides for an edge network replacement for localized Metaverse services. When more than one service anchors are present in the Metaverse service that the user can access, the MNO possesses the facility to replace the edge networks depending on operator priority, user subscription, and point-of-time priority of the services at different service anchors. Since the point-of-time service priority includes the user location information, therefore the MNO may find it feasible to replace the edge network host of a service at a given service anchor with another edge network host e.g., when user is at a specific location. In essence, the MNO is performing relocation of the service for a given service anchor to a different edge network.

As shown in FIG. 10, when the service provided at service anchor 502 is accessed by the user, depending on the point-of-time service priority (e.g., user current location, temporal information etc.), the edge network host or the edge network 802 in which the service is deployed can be changed to a different edge network host or a different edge network 1002. This is the process of service relocation from one edge host to another edge host or a different edge network 1002. The MNO may make such a decision to augment the service performance of the service at the specific service anchor 502 that the user is currently accessing so user would have a better service performance.

Although FIG. 10 illustrates an example edge network host or edge network replacement for localized Metaverse services, various changes may be made to FIG. 10. For example, the number and placement of various components of the network replacement 1000 can vary as needed or desired. In addition, the network replacement 1000 may be used in any other suitable process and is not limited to the specific processes described above.

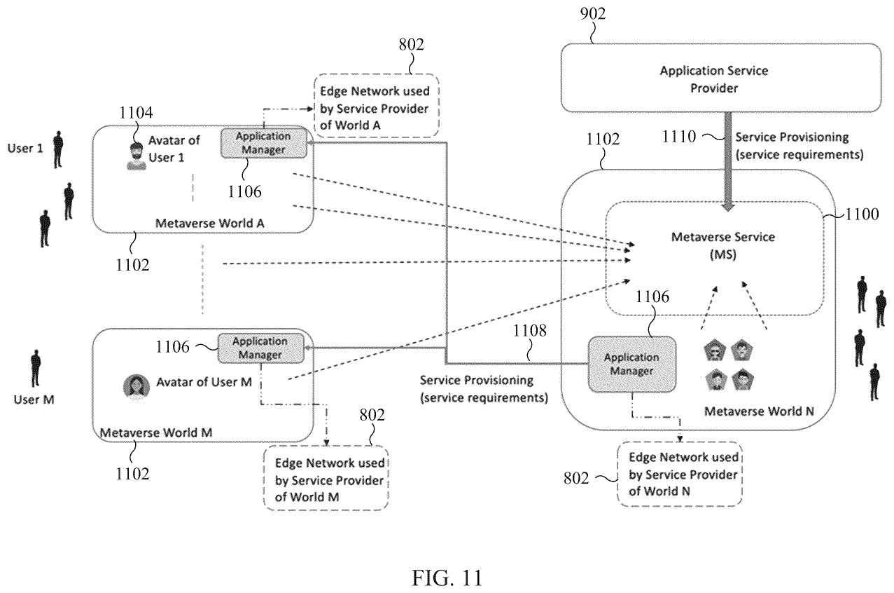

FIG. 11 illustrates an example Metaverse service 1100 with users from different Metaverse worlds in accordance with an embodiment of this disclosure. The embodiment of the Metaverse service 1100 illustrated in FIG. 11 is for illustration only. FIG. 11 does not limit the scope of this disclosure to any particular implementation of an electronic device.

As shown in FIG. 11, Metaverse service 1100 can be provided as streaming services, conversational services, etc. For the streaming services, usually an application service provider 902 can provide a streaming (downlink or uplink) service that the users of the application service provider 902 use. In streaming services, the assets (content) can be pre-identified. Because the streaming services are one-to-one service delivery mechanisms between the application service provider 902 and the user, the streaming sessions are, after optional augmentation, e.g., in an edge network 802, are sent to the UE for consumption. The application service provider 902 typically provides access to edge infrastructure at a given location, i.e., the content is processed and augmented at a same edge location for all users of the streaming service. A collection of edge deployments can be provisioned for a streaming service in case the application service provider 902 intends to distribute the edge processing across multiple edge deployments. However, in this case, a user's session traffic goes through one service in one edge network 802, i.e., user's session traffic is not typically spread over more than one edge service.

For conversational services, an application service provider 902 typically provides a conversational service using that multiple users can participate in a group collaboration type of service (e.g., a conference, meeting etc.). When application service provider intends to provide a higher quality conversational or group service (e.g., using latest high-quality video codecs, or 3D data such as point clouds, light fields etc.), the application service provider 902 typically provides access to one or more edge deployments, and the service traffic for one or more users is processed, optionally augmented, at one edge service (e.g., typically at IMS MRF media node). Even with this kind of edge deployment scenario, one edge service provides facilities for service augmentation for one or more UEs, but the session traffic belonging to one user typically goes to the same edge service.

The Metaverse services 1100 can be more distributed with Metaverse worlds 1102 from different application service providers 902 inter operating with each other. For example, an avatar 1104 registered and generated in Metaverse world A (Metaverse world of vendor A) can enter another Metaverse world B (Metaverse world of vendor B), collaborate and interact with entities in Metaverse world B using the same mechanisms used in Metaverse world A to interact with entities of Metaverse world A.

In certain embodiments, Metaverse service (MS) 1100 can be provided by an ASP 902. The Metaverse service 1100 primarily is setup in negotiation with a Metaverse service provider world N. Many users registered to world N are taking part or using the Metaverse service 1100. In addition, one or more users registered in one or more distinct Metaverse worlds (world A to world M) are also participating and taking part in the Metaverse service 1100.

When such a Metaverse service 1100 is provisioned by an ASP 902, the Metaverse service 1100 sets up Metaverse service metadata, access control information, user lists, endpoint information, authenticate mechanisms, scene description, Metaverse service requirement descriptor, as part of the service provisioning process.

The Metaverse service metadata can include a name, an ID, a setup time, etc. The access control information can include information pertaining to which users can take part or participate in the service. The user lists can include a global identity user list. The endpoint information can include information to access a local domain authentication server. The authenticate mechanisms can include digest authentication, domain authentication, verified identity such as Blockchain authentication using private keys, etc. The scene description can provide a description of the Metaverse service 1100 including a layout of scene/service setting, a list of service anchors, a layout/orientation in 3D of different service anchors, service access information of one or more service anchors in the service setting, etc. The Metaverse service requirement descriptor can include detailed service requirements 1108 for the service. This provides detailed service information desirable for running the Metaverse successfully. Details for the Metaverse service requirements such as the following can be include minimum/maximum/average downlink bit rate requirements, minimum/maximum/average uplink bit rate requirements, minimum/maximum/average latency for any constituent service media streams, minimum/maximum/average downlink throughput requirements, minimum/maximum/average uplink throughput requirements, minimum/maximum/average packet loss rate requirements for both downlink and uplink direction, M1QOS Specification QoS parameters as specified in TS 26512, compute requirements, network requirements, etc.

When the application manager 1106 in the Metaverse world N receives the service provisioning information 1110 from the application service provider 902, the 1106 can perform the following operations.

Based on the service requirements 1108 for the Metaverse service 1100, the application manager 1106 can break down the service requirements 1108 for supporting the users in its own domain, service requirements 1108 for each of the other Metaverse worlds 1102 whose users are participating and taking part in the Metaverse service 1100.

For deriving service requirements 1108 for the world of the application manager 1106 and each of the quality parameters above, the application manager 1106 estimates the parameter budget applicable for enforcing in its own Metaverse world 1102.

Based on the parameter budget the application manager 1106 estimates for each of the parameters for users in its own Metaverse world 1102, the application manager 1106 communicates with each of the application managers 1106 in the other Metaverse worlds 1102 to relay the parameter budget. The amount of parameter budget information relayed to peer Metaverse worlds 1102 depends on the type of quality parameter described above.

For a latency parameter, the parameter budget relayed can equal a total possible latency configured by application service provider 902 and the parameter budget allocated for users in its own world including possible network latencies. For other parameters such as bandwidth, bit rate requirements, throughput, etc., the parameter budget information relayed can be the same as the parameters configured by the application service provider 902.

The application manager 1106 can estimate, based on user subscription information, capabilities, and past history information, generates the edge orchestration information that is needed to instantiate the service components desirable for running the service.

When each of the peer application managers in peer Metaverse worlds 1102 receive the above information from the application manager 1106 in the main Metaverse world M, the peer application managers can configure their received parameter budgets in their own Metaverse worlds 1102. Similar to the main Metaverse world M, the same quality parameters can be enforced for the service in their respective Metaverse worlds 1102. The values for these parameters are based on the relayed parameter budget received from the application manager 1106 in the main Metaverse world M. For example, using the M1 interface specified in 3GPP TS 26501, the ASP 902 can provision service details in the MNO network (e.g., at the 5GMS AF function specified in TS 26.501) as shown in TABLE 4.

TABLE 4

| Field | Description |
|---|---|
| Service-anchor- | Information to build and present service anchors at different locations of |
| presentation | the user's view. |
| | List of service anchors keeps changing. I.e., new services are identified |
| | and inserted by the ASP in user's view dynamically. Therefore, the |
| | service-anchor-presentation could be updated by the ASP very |
| | frequently. With each update, the ASP provides an updated list of service |
| | anchors, and service details such as all the fields mentioned in this table. |
| Service list | List of service descriptors. Each service descriptor consists of the |
| | following information at the very least: |
| | Enable-edge-service: Boolean to indicate whether or not to deploy service |
| | components in an edge network |
| | Service-information: Name of the service |
| | Service-anchor-id: Id of the service anchor that is associated with this |
| | service. When the service anchor is accessed or invoked by the end user, |
| | the service access information associated with this service is accessed by |
| | the end user |
| | Service-access-information: Detailed information that is desirable to |
| | invoke the service. Following information may be part of the service |
| | access information for the service |
| | List of service-component descriptors: List of all streams that are part of |
| | the service (e.g., audio, video, text, tactile etc.). For each media type, |
| | following information may be included: |
| | Protocol |
| | Media Formats and Container-formats |
| | QoS requirements to run the stream of this media type (e.g., QoS |
| | requirements, latency requirements, throughput requirements etc.) |
| | Network-slice-information: Mapping of different service components to |
| | different network slices to be used to carry different streams of the above |
| | service components |
| | Edge Orchestration requirements: Requirements for edge orchestration. |
| | Details such as the following are included: |
| | Edge network host requirements: Type of edge network host e.g., |
| | kubernetes, vm-ware etc. |
| | Number of hosts: Number of hosts needed for setting up service at the |
| | edge |
| | Host requirements: Type of hosting environment required |
| | Processor requirements: Minimum amount of processing resources |
| | required (e.g., vcpu, ram, disk space, gpu etc.) |
| | Network requirements: Type of networking required between different |
| | components of the edge orchestration to enable communication between |
| | multiple microservices that may be deployed to run the service |
| | Replace-edge-network-host: Boolean variable to indicate whether the |
| | mobile operator can replace the edge network host initially chosen by the |
| | ASP for this specific service |
| | Replace-edge-network: Boolean variable to indicate whether the mobile |
| | operator can replace the edge network initially chosen by the ASP for this |
| | specific service |
| | Manage orchestration: Boolean variable to indicate whether the mobile |
| | operator can update the edge orchestration resources. Following are some |
| | of the possibilities: |
| | Host improvements: Improve or reduce the capabilities of the |
| | orchestration system e.g., go from a dedicated instance to a shared |
| | instance, from a general purpose VM to a specialized compute instance |
| | Network improvements: Lower performance network to a higher |
| | performance network |
| Metaverse | Requirements to run the higher level Metaverse service. Details such as |
| service | the following are included: |
| requirements | Enable-edge-deployment: Enable edge network deployment for services |
| | within the Metaverse service |
| | Edge-exclusion-list: List of services within the Metaverse service that |
| | cannot be run in edge networks. For these types of services, the remote |
| | service is the main preferred service instance to be accessed. |
| Edge-network- | Different edge network options available for use by the ASP for the |
| options | Metaverse service. This information is provided by the mobile operator |
| | to ASP |
| Replace-edge- | Boolean variable to indicate whether the mobile operator can replace the |
| network | edge network initially chosen by the ASP for the Metaverse service |
| Metaverse | Detailed information of Metaverse Service provisioned by the |
| service | Application Provider in one of the Metaverse worlds. Information such |
| details | as the following is included: |
| | Metaverse service metadata (e.g., name, Id, setup time etc.) |
| | Access Control information: Information pertaining to which users can |
| | take part or participate in the service. Information such as the following |
| | can be included: |
| | User list (e.g., global identity user list) |
| | Endpoint information to access a local domain authentication server |
| | Authenticate mechanisms (Digest authentication, Domain authentication, |
| | verified identity such as Blockchain authentication using private keys |
| | etc.) |
| | Scene description: Description of the Metaverse service. Information |
| | such as the following can be included: |
| | Layout of scene/service setting |
| | List of service anchors |
| | Layout/orientation in 3D of different service anchors |
| | Service Access Information of one or more service anchors in the service |
| | setting |
| | Metaverse service requirement descriptor: Detailed service requirements |
| | for the service. This provides detailed service information required for |
| | running the Metaverse successfully. Details such as the following can be |
| | included: |
| | Minimum/Maximum/Average Downlink Bit rate requirements |
| | Minimum/Maximum/Average Uplink Bit rate requirements |
| | Minimum/Maximum/Average Latency for any constituent service media |
| | streams |
| | Minimum/Maximum/Average Downlink Throughput requirements |
| | Minimum/Maximum/Average Uplink Throughput requirements |
| | Minimum/Maximum/Average Packet loss rate requirements for both |
| | downlink and uplink direction |
| | M1QoSSpecification QoS parameters as specified in TS 26512 |
| | Compute requirements |
| | Network requirements |

The resource allocation (e.g., compute resources, memory resources, network resources, GPU resources, any other virtual or physical resources allocated for the service in the edge network) for the Metaverse service 1100 in the edge networks 802 can be based on the point-of-time service priority of different services at different service anchors in the Metaverse service 1100. As the point-of-time service priority depends on parameters such as the current location of the user, user's preferences, current time etc., the resource allocation in the edge data network for different services pointed to by different service anchors could depend on the current location of the user, user's preferences, current time.

The resource allocation in the edge networks 802 can be managed in such a way that the resources are scaled-in/scaled-out/scaled-up/scaled-down based on the point-of-time service priority of different sub-services pointed by different service anchors in the Metaverse service 1100.

Although FIG. 11 illustrates an example Metaverse service with users from different Metaverse worlds, various changes may be made to FIG. 11. For example, the number and placement of various components of the Metaverse service 1100 can vary as needed or desired. In addition, the Metaverse service 1100 may be used in any other suitable process and is not limited to the specific processes described above.

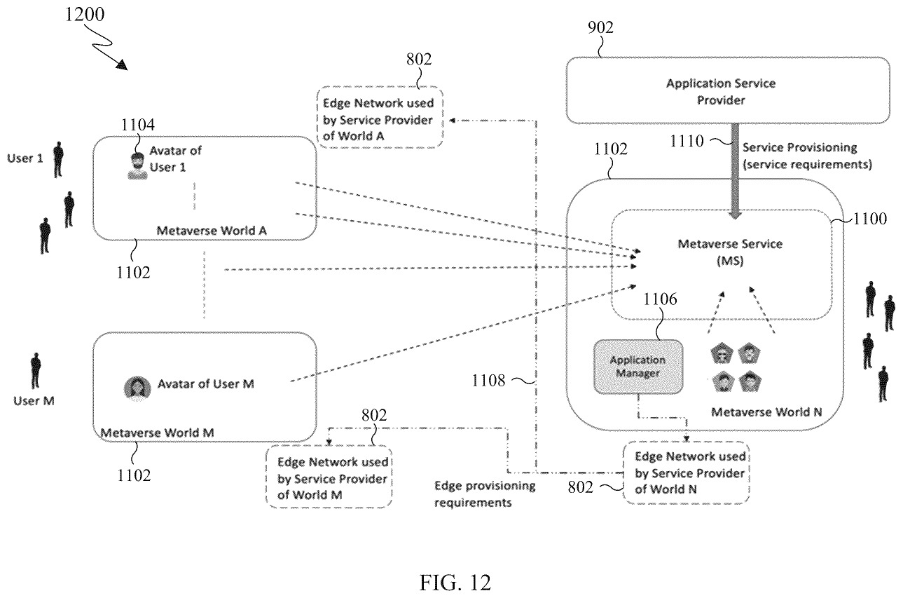

FIG. 12 illustrates an example connected edge for peer Metaverse world edge orchestration provisioning 1200 in accordance with an embodiment of this disclosure. The embodiment of the provisioning 1200 illustrated in FIG. 12 is for illustration only. FIG. 12 does not limit the scope of this disclosure to any particular implementation of an electronic device.

As shown in FIG. 12, connected edge for peer world provisioning 1200 can provide for edge orchestration. The earlier embodiment describes a distributed Metaverse service 1100 with details of service provisioning which ultimately results in edge orchestration in each of the peer Metaverse worlds 1102. In certain embodiments, one or more of the peers Metaverse worlds 1102 do not have an application manager 1106 required to support configuration of parameter budgets and invoke edge orchestration instantiations.

In this case, once the application manager 1106 in the main Metaverse world M receives the service provisioning information 1110 from the application service provider 902, the edge orchestration requirements are derived as described in the earlier embodiment and informs the edge orchestration manager in the Metaverse world 1102. The application manager 1106 also informs the edge orchestration manager in its own Metaverse world 1102 with service requirements for each of the peer Metaverse worlds 1102. To communicate with peer Metaverse world edge orchestration engine, the application manager 1106 can inform necessary endpoint information for its edge orchestration manager to contact other application manager 1106. When the edge orchestration manager receives this information from the application manager 1106, the edge orchestration manager contacts each of the edge orchestration endpoints with broken down service requirement information and edge orchestration requirements. When the edge orchestration manager supporting each of the peer Metaverse worlds 1102 receive this information, the edge orchestration manager can setup the required edge orchestration for supporting users in their own Metaverse world 1102.

TR 22.856 specifies a study of localized Metaverse services 1100 and includes a number of potential use-cases and requirements for Metaverse services 1100. Clause 5.1 of TR 22.856 describes the use case of localized Metaverse service with service anchors placed in user's field of view for the user to choose if the user wants to access that service. The use case describes a scenario where in the user is walking in an airport, and is presented with a number of localized Metaverse services 1100 that the user can access. These services are provided as service anchors in the user's physical environment. The user may select the service that the user wants to access and invoke the service.

As a non-limiting example, an end user is driving a car on the way to a repair shop. A Metaverse service scene can be presented to the end user with a multitude of services that the end user can access, e.g., map service, music service, and shopping service. The end user may have his car in auto-driving mode and invoke the service anchor corresponding to the shopping service to buy tires for his car before the user reaches the repair shop. The end user may wish to stream audio and video content related to the products the user is buying. A best effort network might not be serving the end user's needs. The end user activates a premium subscription service to perform his tasks.

Although FIG. 12 illustrates an example connected edge for peer Metaverse world edge orchestration provisioning, various changes may be made to FIG. 12. For example, the number and placement of various components of the provisioning 1200 can vary as needed or desired. In addition, the provisioning 1200 may be used in any other suitable process and is not limited to the specific processes described above.

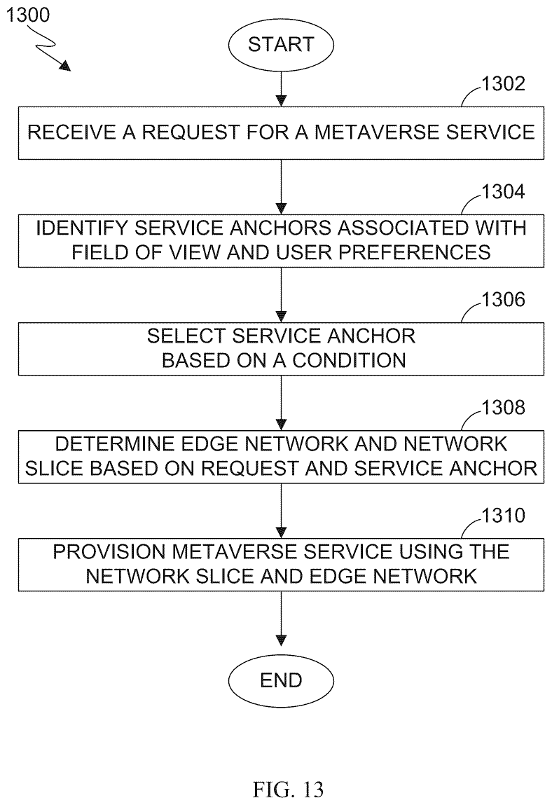

FIG. 13 illustrates an example method for Metaverse services with network slicing according to this disclosure. For ease of explanation, the method 1300 of FIG. 13 is described as being performed using the electronic device 300 of FIG. 3. However, the method 1300 may be used with any other suitable system and any other suitable electronic device.

As shown in FIG. 13, the electronic device 300 can receive a request for a Metaverse service at step 1302. The request can originate from a UE that is accessing a Metaverse world or using a Metaverse service. The request can be received by an application service provider that can provide service provisioning and service requirements to an application manager or an edge network providing the Metaverse service. The requests can include one or more of a service name, a service ID, a setup time, access control information, and a Metaverse service requirement descriptor.

The electronic device 300 can identify service anchors associated with a field of view and user preferences at step 1304. One or more service anchors associated with (i) a field of view of a user and (ii) preferences of the user can be identified. The service anchors provided to a user can be updated or change based on a current location (e.g., movement of a user), user preferences (e.g., a specified activity a user is participating in or on the way to participate in), current time, etc.

The electronic device 300 can select a service anchor based on a condition at step 1306. A service anchor from the one or more service anchors can be selected based on a condition. The service anchors provided to the user can be selected based on user input, proximity, user preferences, time of day, etc. The condition for selecting the service anchor is based on at least one of a current location of the user and the preferences of the user.

The electronic device 300 can determine an edge network and a network slice based on the request and the service anchor at step 1308. One or more edge networks and one or more network slices can be determined based on (i) the request and (ii) the service anchor. The Metaverse services on multiple service anchors can be provided over network stream from a single network slice, can be provided by combining into network streams by multiple network slices, and over separate network streams by separate multiple network slices. In certain embodiments, the Metaverse services can be provided by service anchors supported by different edge networks.

The electronic device 300 can identify that each of the one or more service anchors use a unique network slice for providing the Metaverse service. The slice resources of the one or more service anchors associated with the field of view can be reserved. The reserved slice resources of a specified service anchor can be activated when the user is within a threshold distance (geographic distance or service delay distance) of the specified anchor. The specified distance can include a lowest distance from the UE to a service anchor or can be user specified distances thresholds for specific service anchors, etc. The electronic device can identify that a first and second service anchors from the one or more service anchors have a same priority. The priority can be based on the conditions for identifying service anchors. The slice resources of a same network slice can be allocated based on identifying that the first and the second service anchors have the same service priority. A service priority can be identified for the service anchor. The slice resources can be scaled for the service anchor based on the service priority. In one example, when there are ten service anchors in user's field of view, considering the time of day and user's personal choice favoring dining over watching movies, five of those ten service anchors are identified.

The electronic device 300 can provision a Metaverse service using the network slice and the edge network at step 1310. The Metaverse service can be provisioned using the one or more network slices and the one or more edge networks. The UE can consume the Metaverse services over the specified network slice and edge network. The condition for selecting the service anchor can be based on a change in location of the user or change in the one or more service anchors. Continuing with the earlier example, based on the user's current location and taste preferences (e.g., prefer Mediterranean cuisine over Italian cuisine), a service anchor is selected.

Although FIG. 13 illustrates an example method for Metaverse services with network slicing, various changes may be made to FIG. 13. For example, while shown as a series of steps, various steps in FIG. 13 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element. step, or function is an essential element that must be included in the claims scope. The scope of patented subject matter is defined by the claims.

What is claimed is:

1. A method for an application function comprising:
receiving a request for a Metaverse service;
identifying one or more service anchors associated with (i) a field of view of a user and (ii) preferences of the user;
selecting a service anchor from the one or more service anchors based on a condition;
determining one or more edge networks and one or more network slices based on (i) the request and (ii) the service anchor; and
provisioning the Metaverse service using the one or more network slices and the one or more edge networks.

2. The method of claim 1, wherein the condition for selecting the service anchor is based on at least one of a current location of the user and the preferences of the user.

3. The method of claim 1, further comprising:
updating the one or more network slices or the one or more edge networks based on a change in location of the user or change in the one or more service anchors.

4. The method of claim 1, wherein the request includes one or more of a service name, a service ID, a setup time, access control information, and a Metaverse service requirement descriptor.

5. The method of claim 1, further comprising:
identifying that each of the one or more service anchors use a unique network slice for providing the Metaverse service;
reserving slice resources of the one or more service anchors associated with the field of view of the user; and
activating reserved slice resources of a specified service anchor as the user is within a threshold distance of the specified service anchor.

6. The method of claim 1, further comprising:
identifying that a first service anchor and a second service anchor from the one or more service anchors have a same service priority; and
allocating slice resources of a same network slice based on identifying that the first service anchor and the second service anchor have the same service priority.

7. The method of claim 1, further comprising:
identifying a service priority of the service anchor; and
scaling slice resources for the service anchor based on the service priority.

8. An application function comprising:
a transceiver; and
a processor configured to:
receive, via the transceiver, a request for a Metaverse service,
identify one or more service anchors associated with (i) a field of view of a user and (ii) preferences of the user,
select a service anchor from the one or more service anchors based on a condition,
determine one or more edge networks and one or more network slices based on (i) the request and (ii) the service anchor, and
provision the Metaverse service using the one or more network slices and the one or more edge networks.

9. The application function of claim 8, wherein the condition for selecting the service anchors is based on at least one of a current location of the user and the preferences of the user.

10. The application function of claim 8, wherein the processor is further configured to:
update the one or more network slices or the one or more edge networks based on a change in location of the user or change in the one or more service anchors.

11. The application function of claim 8, wherein the request includes one or more of a service name, a service ID, a setup time, access control information, and a Metaverse service requirement descriptor.

12. The application function of claim 8, wherein the processor is further configured to:
identifying that each of the one or more service anchors use a unique network slice for providing the Metaverse service;
reserve slice resources of the one or more service anchors associated with the field of view of the user; and
activate reserved slice resources of a specified service anchor as the user is within a threshold distance of the specified service anchor.

13. The application function of claim 8, wherein the processor is further configured to:
identifying that a first service anchor and a second service anchor from the one or more service anchors have a same service priority; and
allocating slice resources of a same network slice based on identifying that the first service anchor and the second service anchor have the same service priority.

14. The application function of claim 8, wherein the processor is further configured to:
identify a service priority of the service anchor; and
scale slice resources for the service anchor based on the service priority.

15. A non-transitory computer readable medium containing instructions that when executed cause a processor to:
receive a request for a Metaverse service;
identify one or more service anchors associated with (i) a field of view of a user and (ii) preferences of the user;
select a service anchor from the one or more service anchors based on a condition;
determine one or more edge networks and one or more network slices based on (i) the request and (ii) the service anchor; and
provision the Metaverse service using the one or more network slices and the one or more edge networks.

16. The non-transitory computer readable medium of claim 15, wherein the condition for selecting the service anchor is based on at least one of a current location of the user and the preferences of the user.

17. The non-transitory computer readable medium of claim 15, wherein the instructions further cause the processor to:
update the one or more network slices or the one or more edge networks based on a change in location of the user or change in the one or more service anchors.

18. The non-transitory computer readable medium of claim 15, wherein the request includes one or more of a service name, a service ID, a setup time, access control information and a Metaverse service requirement descriptor.

19. The non-transitory computer readable medium of claim 15, wherein the instructions further cause the processor to:
identify that each of the one or more service anchors use a unique network slice for providing the Metaverse service;
reserve slice resources of the one or more service anchors associated with the field of view of the user; and
activate reserved slice resources of a specified service anchor as the user is within a threshold distance of the specified service anchor.

20. The non-transitory computer readable medium of claim 15, wherein the instructions further cause the processor to:
identify that a first service anchor and a second service anchor from the one or more service anchors have a same service priority; and
allocate slice resources of a same network slice based on identifying that the first service anchor and the second service anchor have the same service priority.
